(19) United States
(12) Patent Application Publication
(10) Pub. No.: US 2017/0352017 A1
(43) Pub. Date: Dec. 7, 2017

(54) CLOSE PROXIMITY ORDERING AND PAYMENT SYSTEM AND METHOD

(71) Applicant: Ronny Hay, Encino, CA (US)

(72) Inventor: Ronny Hay, Encino, CA (US)

(21) Appl. No.: 15/610,093

(22) Filed: May 31, 2017

Related U.S. Application Data
(60) Provisional application No. 62/343,971, filed on Jun. 1, 2016.

(51) Int. Cl. G06Q 20/20; G06Q 50/12; G06Q 20/24

(52) U.S. Cl. CPC G06Q 20/202; G06Q 20/24; G06Q 50/12

(57) ABSTRACT

A system and method is provided that allows consumers to locate a restaurant in a network of restaurants participating in the system, notify the restaurant of the consumers' impending visit, review the menu and order food at the restaurant, communicate with wait staff and other restaurant workers at the restaurant, and view and pay the check, all using the consumer's smartphone or other mobile communications device. The system also detects the consumer's presence at the participating restaurant, and it establishes an active transaction between the consumer and the restaurant from the time the consumer first enters the establishment until the consumer's payment is processed and the transaction is completed. The system and method may apply to restaurants or other business establishments.

### CROSS-REFERENCES TO RELATED APPLICATIONS

This application claims priority from U.S. Provisional Application No. 62/343,971, filed Jun. 1, 2016, which is incorporated by reference in its entirety.

### BACKGROUND

The present invention generally relates to a close proximity order and payment system and method, and more particularly relates to a close proximity ordering and payment system mainly designed for use by consumers visiting participating restaurants or other establishments.

The dining experience is largely hit or miss. While some restaurants offer excellent service and respond to a consumer's request correctly and promptly, other restaurants may not, whether because they are too busy or otherwise. Reservations may be lost, food mix-ups may occur, requests for drink refills may be forgotten, or the check may be delayed or wrongfully charged. Such shortcomings can ruin the dining experience, and damage a restaurant's reputation. A need to improve the dining experience and a provide a solution to address these shortcomings is therefore required. The present invention addresses this and other needs.

### SUMMARY OF THE INVENTION

The present invention is directed to a system and method that allows consumers to locate a restaurant in a network of restaurants participating in the system, notify the restaurant of the consumers' impending visit, review the menu and order food, communicate with wait staff and other restaurant workers at the restaurant, and view and pay the check, all using the consumer's smartphone or other mobile communications device. The system also detects the consumer's presence at the participating restaurant, and it establishes an active transaction between the consumer and the restaurant from the time the consumer first enters the establishment until the consumer's payment is processed and the transaction is completed.

The system includes dedicated hardware, including a main server, and an interface and communications unit that communicates with the main server and is located on the restaurant's premises. The system also uses a proprietary software application that allows the main server to communicate with the interface and communications unit, as well as with the consumers' mobile communications devices. One or more databases communicate with the server that stores information used in the system. For example, the one or more databases can store a list of participating restaurants, consumer menu historical orders and checks, and the like.

The software application is configured to facilitate the consumer's dining experience by performing at least the following functions: 1) communicating a consumer's request to initiate a transaction session (e.g. visit and eat at a restaurant) to the main server; 2) locating and displaying information about restaurants in close proximity to the consumer's current location in response to the consumer's request; 3) communicating a consumer's request to visit a selected restaurant to the restaurant's interface and communications unit to notify the restaurant that the consumer is planning to visit and to assign a table number; 4) displaying a restaurant menu that was preloaded into the restaurant's interface and communications unit (or stored previously on the main server) on the consumer's mobile communications device; 5) transmitting the consumer's menu order to the restaurant's interface and communications unit for wait staff to process; 6) facilitating dialogue between the consumer and restaurant workers by use of a messaging or chat feature (e.g. when the consumer requires a drink refill, etc.) preferably including audio files and voice communication; 7) displaying the consumer's bill on the consumer's mobile communications device; and 8) processing the consumer's payment of the bill and thereby completing the transaction between the consumer and restaurant. The server charges the consumer's credit card on file and issues a payment confirmation slip to the restaurant. The payment slip may then be printed and/or saved on the interface and communications unit of that restaurant.

In this way, the system improves the accuracy and efficiency of the restaurant and of the dining experience. Since consumers' orders and messages are electronically sent to and displayed on the restaurant interface and communications unit, wait staff can quickly process the orders and respond to the messages without keeping the consumer waiting too long. Additionally, incorrect charges on the bill are greatly reduced, since the consumer's orders and costs are logged in the system and retrievable by the consumer at the click of a button on the smartphone. Moreover, the system is easy to use, as customers need only download the software application to their smartphone to locate and dine at a participating restaurant. The shortcomings of restaurants identified above are thereby addressed. Additionally this system may reduce the need for staff members and save operation cost.

Restaurants may be selected to participate in the network by means known to one of ordinary skill in the art. For example, the restaurant may call an administrator for the system to manually include the restaurant in the system's network of participating restaurants, or the software application or a website may be configured to communicate the restaurant's request to the administrator. The restaurant's interface and communications unit may thereafter be installed by the system administrator on the restaurant's premises. The main server may be located in the cloud or alternatively may be installed on the restaurant's premises.

It should be understood that although reference has been made herein to participating restaurants in particular, the close proximity ordering and payment system and method may apply to any other business establishment desiring to participate in the system's network.

These and other features and advantages of the present invention will become apparent from the following detailed description of preferred embodiments which, taken in conjunction with the accompanying drawings, illustrate by way of example the principles of the invention.

### BRIEF DESCRIPTION OF THE DRAWINGS

FIG. 1 is a schematic diagram of a close proximity ordering and payment process for a consumer at a participating establishment in accordance with a preferred embodiment of the present invention.

FIG. 2 is a schematic diagram depicting a consumer ordering process in the participating establishment, here in particular, a restaurant, according to a preferred embodiment of the present invention.

FIG. 3 is a schematic diagram depicting a messaging process in the participating establishment, here in particular, a restaurant, according to a preferred embodiment of the present invention.

FIG. 4 is a schematic diagram depicting a consumer payment process in the participating establishment, here in particular, a restaurant, according to a preferred embodiment of the present invention.

FIG. 5 is a schematic diagram of a close proximity ordering and payment system in accordance with a preferred embodiment of the present invention.

### DETAILED DESCRIPTION OF THE PREFERRED EMBODIMENTS

The close proximity ordering and payment system and method allow consumers to facilitate the dining process by means of a restaurant interface and communications unit located at the restaurant's premises, an associated software application downloadable to a consumer's smartphone or other mobile communications device, and a remote server in communication with the restaurant interface and communications unit and the mobile communications device.

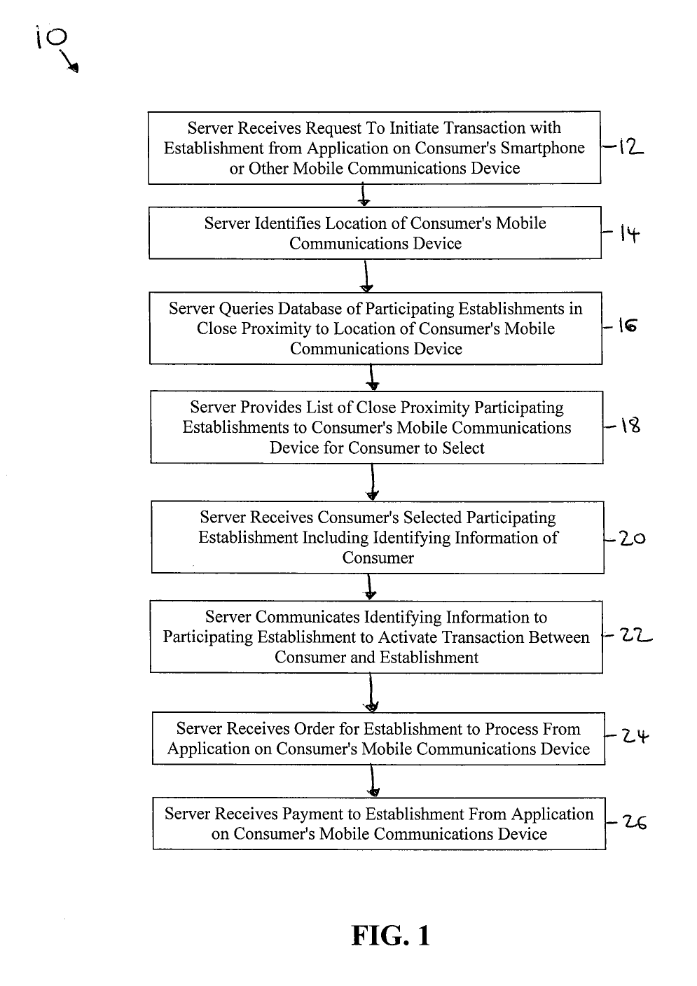

Referring to FIG. 1, a close proximity ordering and payment method 10 is provided. First, a consumer desiring to locate a restaurant or other establishment with which to engage in a transaction (e.g. to dine in a restaurant) activates the software application on the consumer's mobile communications device, and the server receives the consumer's transaction initiation request from the mobile communications device 12. The request includes location information of the mobile communications device, such as Global Positioning Satellite (GPS) coordinates, from which the server identifies the location of the consumer 14. Moreover, the request includes the search preferences of the consumer, including a distance from the consumer within which to locate participating establishments. For example, the consumer may request to only search for participating restaurants located within 1 mile of the consumer's mobile device's current location. Alternatively, the software application may be configured to only search for participating restaurants located within a predetermined distance of the consumer's mobile communications device, or to search by the type of establishment, based on numerous different search criteria. In either case, only close proximity locations are identified.

Once the server identifies the location of the consumer's mobile communications device and the consumer's search preferences, the server queries a database of participating restaurants or other establishments that are within the distance the consumer specified 16. The server thereafter sends the resulting list of close proximity participating establishments to the consumer's mobile communications device for the consumer to review 18. Once the consumer selects a particular participating establishment to visit in the software application, for example by clicking the name of the establishment, identifying information regarding the consumer is transmitted from the mobile communications device to the server 20. Such identifying information includes the name and party size of the consumer, and may also include the name of the restaurant or other establishment.

Afterwards, the server communicates with the selected restaurant or establishment 22. In particular, the server notifies the restaurant's interface and communication unit of the consumer's upcoming visit, thereby activating a transaction session between the consumer and the establishment. The server can thereafter receive orders from the consumer, such as dine-in or pickup, and transmit those orders to the restaurant's interface and communication unit to be processed 24. The server can also receive payment for orders from the consumer, transmit the consumer's payment information to a payment processor to be processed, and provide a confirmation of payment to the restaurant's interface and communications unit when the transaction is completed 26.

Additionally, at this point, a dialogue can be opened between the consumer and the establishment for receiving and transmitting messages. For example, after the restaurant interface and communication unit is notified that the restaurant is the consumer's selected establishment, the restaurant can inform the consumer when his or her table will be ready if the consumer plans to dine-in, when the consumer's food is available to pick-up if the consumer plans to order take-out, if the consumer can provide a positive review for the restaurant's food and/or service after a transaction is completed, and the like. A chat communication may also be initiated between the consumer and the restaurant in which the consumer's reservation at the restaurant can be confirmed or the consumer can pre-order food for dining in or takeout. An automated reply system may also be included allowing the restaurant's interface and communications unit to notify the consumer how long the wait is for a table, or provide any other message such as the list of that day's food specials and other promotions at the restaurant.

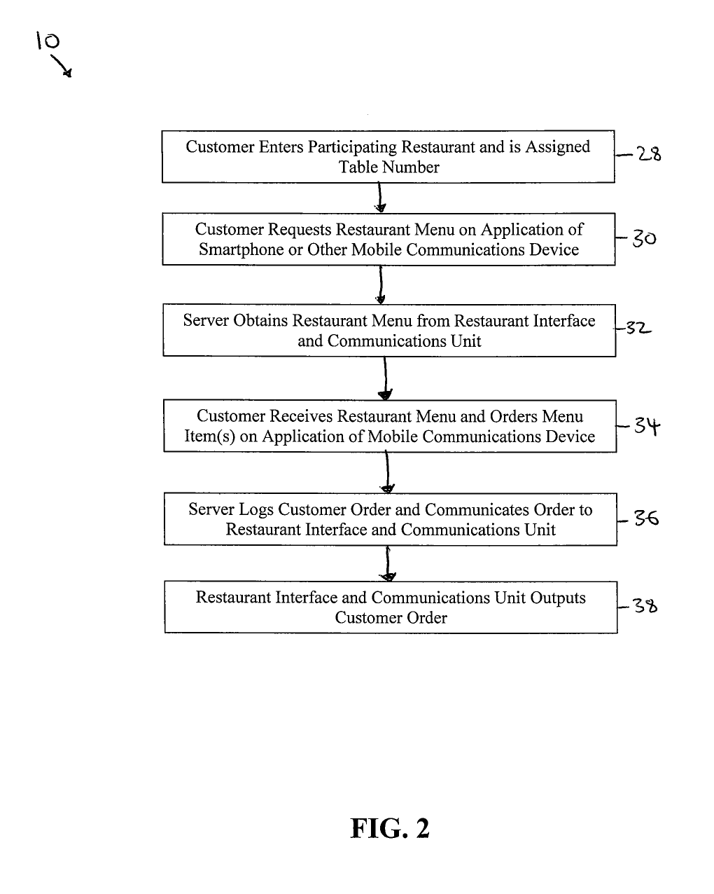

Referring now to FIG. 2, after the consumer enters the restaurant and his or her table is ready, the restaurant's assigned table number is submitted to the server with the consumer's identifying information 28. In this way, the establishment knows at what table the consumer is sitting. The waiter or waitress may submit the consumer's assigned table number to the server using the interface and communications unit. Alternatively, the consumer may submit his or her assigned table number directly to the server using the software application on the consumer's mobile communications device.

Once the consumer is seated, the consumer requests to view the restaurant's menu on the software application of the consumer's mobile communications device 30. Previously, the restaurant's menu was loaded and stored by the establishment in the restaurant interface and communications unit, such as by scanning the individual pages of the restaurant's menu or by typing its contents. In this way, after the server receives the consumer's request, the server retrieves the restaurant menu stored in the restaurant interface and communications unit and transmits it to the consumer's mobile communications device 32. Alternatively, the restaurant menu may be preloaded and stored by the establishment also in the server, which, in turn, transmits the restaurant menu from its memory to the consumer's mobile communications device. Images and pictures associated with the restaurant and/or each menu item and prices are displayed on the software application of the consumer's mobile communications device. Additionally, the menu is properly formatted for display on the mobile communications device.

After the consumer receives and reviews the menu, including images or pictures, on the software application of the mobile communications device, the consumer selects the menu item(s) he or she would like to order in the application, such as by clicking each menu item or entering a quantity for each item 34, and sends the order. The server receives the consumer's ordered items, logs them in the database, and communicates the order to the restaurant interface and communications unit to be processed 36. The restaurant interface and communications unit may output the consumer's order to the wait staff on a display, such as a touch screen 38. Alternatively, the restaurant interface and communications unit may include a printer that prints the consumer's order slip. Additionally, the restaurant interface and communications unit may be interfaced with the restaurant's existing ordering and processing system and will automatically log the order and the payment in the system.

While the consumer is waiting for his or her order, and while the consumer is dining, the consumer may desire to communicate with the workers at the restaurant. For example, the consumer may desire a drink refill, to order an additional menu item, or to make other requests of the wait staff. Accordingly, the system includes a messaging chat feature that the consumer can use at his or her leisure.

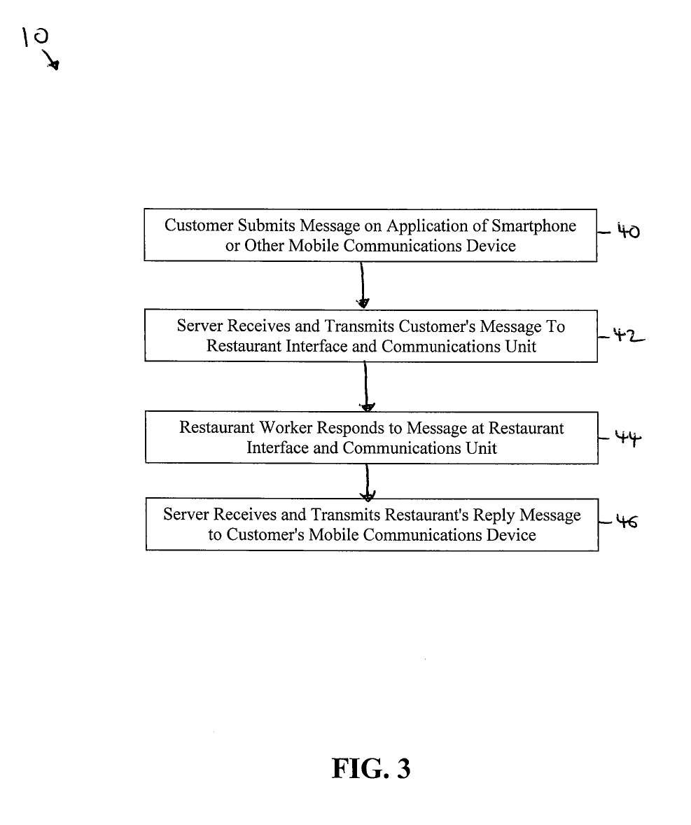

Referring to FIG. 3, the consumer submits a message to the server on the software application of the mobile communication's device 40. For example, the consumer may type on the mobile communications device “More Water Please” or other similar requests. Alternatively, frequently used requests may be displayed as hotkeys, images, or the like on the software application for the consumer to simply click on to submit. The message preferably includes identifying information for the consumer, such as the consumer's assigned table number, to assist the restaurant workers in determining the source of the message. Once the server receives the consumer's message, the server transmits the message to the restaurant interface and communications unit 42. The restaurant interface and communications unit outputs the message, for example using the display or printer, including the consumer's assigned table number, for wait staff, management, or other restaurant workers to address.

Wait staff, management, and other restaurant workers may likewise use the restaurant interface and communications unit to respond to the consumer's message 44. For example, the restaurant worker may type a reply message on the display that the consumer's refill is forthcoming, or if the consumer has a grievance, that the manager is on his or her way to the consumer's table. After the restaurant worker submits the reply message to the restaurant interface and communications unit, the server receives the reply message and transmits it to the consumer's mobile communications device, on which it is displayed to the consumer 46. In this way, consumers can request refills, reorders, or make other requests to employees at restaurants and other establishments without being required to physically flag a person down, thereby saving time, improving efficiency, and uplifting the dining experience.

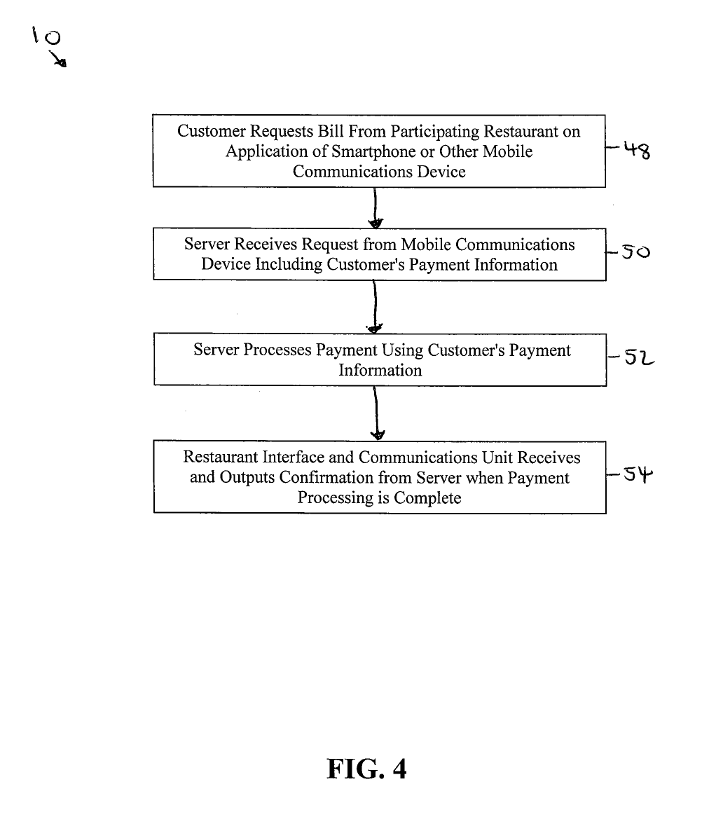

Now referring to FIG. 4, when the consumer is finished dining, the consumer pays the check from the consumer's mobile communications device. In particular, the consumer sends a request to the server for the bill on the software application of the consumer's mobile communications device 48. The bill may be requested using the messaging feature described above, in response to which the restaurant worker may scan or type the bill into the restaurant interface and communications unit and send the bill to the consumer's mobile communications device. Alternatively, a consumer's menu orders and costs are logged in the database, and are queried, transmitted, and displayed on the consumer's mobile device in response to the consumer's request for the bill.

Once the consumer receives and reviews the bill on the mobile communications device, the consumer provides payment information to the software application 50. Payment information may include tip and credit/debit card with associated billing information, and the like. Also the payment can be processed using a credit card previously stored in the system or by paying the fund directly from the customer's bank account. After the consumer submits its request to the server to pay the bill, the server processes the payment using the consumer's payment information 52. Payment is processed using systems known to those in the art. For example, point of sale platforms and payment processing solutions by First Data®, Apriva®, Worldpay® or other companies alike can be integrated into the server or restaurant interface and communications unit to process the payment.

Once the payment is successfully processed, the server notifies the restaurant interface and communications unit that the payment of the consumer's bill was paid along with identifying information for the payment transaction, such as the amount paid, the tip and a transaction number 54. The restaurant interface and communications unit receives and displays the confirmation of payment. For record purposes, the restaurant worker can print the confirmation slip, or store it in the memory of the restaurant interface and communications unit or on the server. Additionally, the restaurant interface and communications unit may be integrated with the existing restaurant system and update that system accordingly.

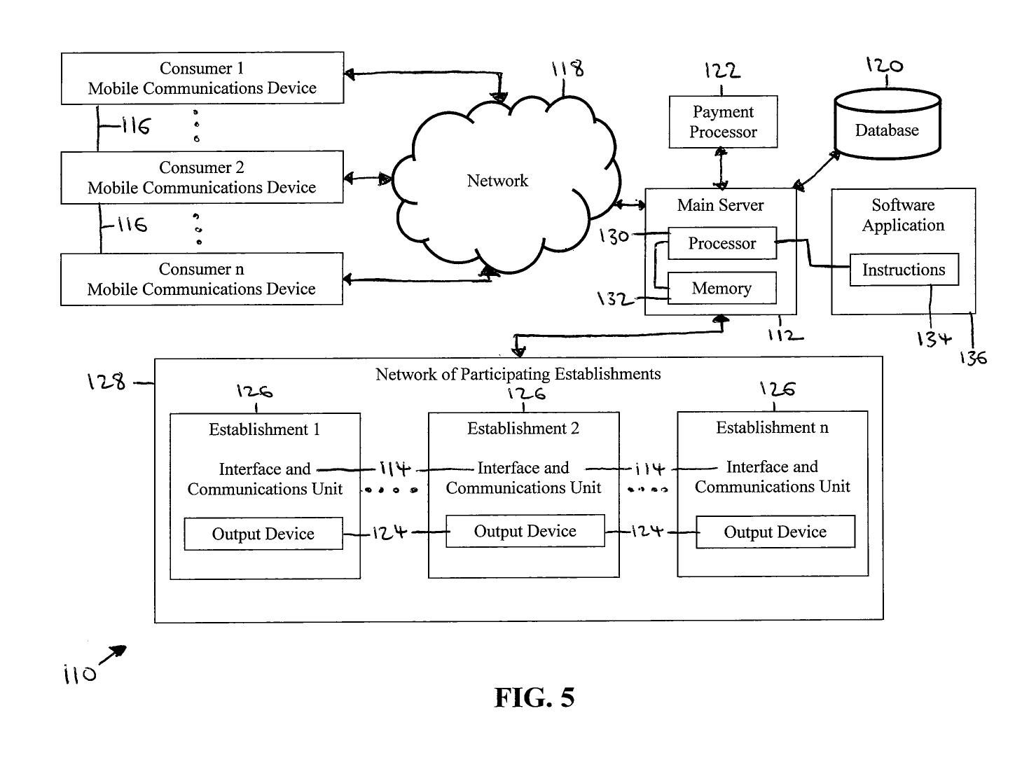

FIG. 5 illustrates a preferred embodiment of the close proximity ordering and payment system 110. In particular, the system includes a server 112 in communication with a plurality of interface and communications units 114 and a plurality of mobile communications devices 116 of consumers over a network 118. The server 112 communicates with a database 120 that stores a list of restaurants and other establishments participating in the system 110, and a payment processor 122 that processes payment by consumers. The server 112 may be located in the cloud, or alternatively, in each restaurant or other establishment. Each interface and communications unit 114 includes an output device 124, which can be a touch screen display and/or a printer. The interface and communication units 114 are individually located in restaurants or other establishments 126 that are part of a participating network 128, where they are accessed by respective restaurant workers. The mobile communications devices 116 may include smartphones, tablets, laptops, and other similar devices. Network 118 may be a local area network (LAN), a metropolitan area network (MAN), a wide area network (WAN), or an interconnection of multiple computer networks (e.g., the Internet).

The server 112 includes a processor 130 and a memory 132, as does the mobile communications devices 116 (not shown). These processors include hardware for executing computer-executable instructions 134 produced by a software application 136 downloadable to the mobile communications devices that performs the steps described above in close proximity order and payment method 10. Software modules including computer-executable instructions 134 for execution by the processors may reside in the memories. Herein, reference to software may encompass one or more applications, byte code, one or more computer programs, one or more executables, one or more instructions, logic, machine code, one or more scripts, or source code, and vice versa, where appropriate. Memory 132 may be random access memory (RAM), including static random access memory (SRAM) and dynamic random access memory (DRAM), read-only memory (ROM), or a persistent store, such as a mass storage device, hard drives, CD-ROM, DVD-ROM, tape, erasable programmable read-only memory (EPROM or flash memory), or any magnetic, electromagnetic, infrared, optical, or electrical system, apparatus or device for storing information.

While certain embodiments have been illustrated and described herein, those embodiments are not necessarily to be construed as advantageous over other embodiments for implementing the method and system of the present subject matter. Other variations and equivalents are possible and should be considered within the scope of the present subject matter.

What is claimed is:

1. A method for operating a close proximity order and payment system, comprising:
receiving into the server a request from a mobile communications device of a consumer to locate a specific type establishment within a predetermined distance of a location of the consumer that is determined to be in close proximity to the consumer;
identifying a current location of the mobile communications device in response to the request from the consumer;
querying a list of one or more establishments located within a predetermined distance of the current location of the mobile communications device, and providing the list of one or more establishments to the mobile communications device to be displayed thereon;
receiving into the server a request from the mobile communications device of the consumer to initiate a transaction with a selected establishment from the list of one or more establishments including identifying information of the consumer, and communicating the identifying information of the consumer to the selected establishment to activate the transaction between the consumer and the establishment;
establishing a chat messaging channel between the consumer and the establishment;
receiving into the server an order to the establishment from the mobile communications device of the consumer, and outputting the order to the establishment on an interface and communications unit located at the establishment; and
receiving payment information of the consumer into the server from the mobile communications device, processing the payment information, outputting a confirmation of payment by the consumer on the interface and communications unit, and completing the transaction between the consumer and the establishment.

2. The method of claim 1, wherein the payment information includes at least one of a credit card on file for the consumer or a bank account of the consumer.

3. The method of claim 1, wherein the establishment is a restaurant.

4. The method of claim 3, further comprising receiving into the server an assigned table number of the consumer from at least one of the mobile communications device and the interface and communications unit.

5. The method of claim 3, further comprising receiving a request into the server for a restaurant menu and other relevant information from the mobile communications device of the consumer, obtaining the restaurant menu from the interface and communications unit, and transmitting the restaurant menu and other relevant information to the mobile communications device to be displayed thereon.

6. The method of claim 5, wherein the restaurant menu is uploaded and stored on the interface and communications unit and on the server by at least one of scanning or typing.

7. The method of claim 3, further comprising logging the order into the database.

8. The method of claim 3, further comprising receiving a chat message into the server from the mobile communications device of the consumer, transmitting the chat message to the interface and communications unit, receiving into the server a reply chat message from the interface and communications unit, and transmitting the reply chat message to the mobile communications device to be displayed thereon.

9. The method of claim 3, further comprising receiving a request for a bill from a mobile communications device of the consumer, and transmitting the bill to the mobile communications device to be displayed thereon.

10. A close proximity ordering and payment system comprising:
a server connected to a network, the server including a processor and a memory;
a database in communication with the server;
an interface and communications unit in communication with the server, the interface and communications unit including an output device;
computer-readable instructions stored in the memory that when executed on the processor, cause the processor to perform the following steps:
receiving into the server a request from a mobile communications device of a consumer to initiate a transaction with an establishment;
identifying a current location of the mobile communications device in response to the request from the consumer to initiate the transaction;
querying a list of one or more establishments located within a predetermined distance of the current location of the mobile communications device, and providing the list of one or more establishments to the mobile communications device to be displayed thereon;
receiving into the server from the mobile communications device a selected establishment from the list of one or more establishments including identifying information of the consumer, and communicating the identifying information of the consumer to the selected establishment to activate the transaction between the consumer and the selected establishment;
receiving into the server an order to the establishment from the mobile communications device of the consumer, and outputting the order to the establishment on the interface and communications unit; and
receiving payment information of the consumer into the server from the mobile communications device, processing the payment information, outputting a confirmation of payment by the consumer on the interface and communications unit, and completing the transaction between the consumer and the establishment.

11. The system of claim 10, wherein the payment information includes at least one of a credit card on file for the consumer or a bank account of the consumer.

12. The system of claim 10, wherein the establishment is a restaurant.

13. The system of claim 12, wherein the computer-executable instructions further include the step of receiving into the server an assigned table number of the consumer from at least one of the mobile communications device and the interface and communications unit.

14. The system of claim 12, wherein the computer-executable instructions further include the steps of receiving a request into the server for a restaurant menu from the mobile communications device of the consumer, obtaining the restaurant menu and other specials and promotions from the interface and communications unit, and transmitting such information to the mobile communications device to be displayed thereon.

15. The system of claim 14, wherein the restaurant menu is uploaded to the interface and communications unit by at least one of scanning or typing.

16. The system of claim 12, wherein the computer-executable instructions further include the step of logging the order into the database.

17. The system of claim 12, wherein the computer-executable instructions further include the steps of receiving a message into the server from the mobile communications device of the consumer, transmitting the message to the interface and communications unit, receiving into the server a reply message from the interface and communications unit, and transmitting the reply message to the mobile communications device to be displayed thereon.

18. The system of claim 12, wherein the computer-executable instructions further include the steps of receiving a request for a bill from a mobile communications device of the consumer, and transmitting the bill to the mobile communications device to be displayed thereon.
